(19) United States
(12) Patent Application Publication
(10) Pub. No.: US 2026/0038735 A1
(43) Pub. Date: Feb. 5, 2026

(54) COIL ASSEMBLY

(71) Applicant: DENSO CORPORATION, Kariya-city (JP)

(72) Inventors: Shimpei TAKITA, Kariya-city (JP); Masaki Kanesaki, Kariya-city (JP); Eisuke Takahashi, Kariya-city (JP)

(73) Assignee: DENSO CORPORATION, Kariya-city (JP)

(21) Appl. No.: 19/354,521

(22) Filed: Oct. 9, 2025

Related U.S. Application Data
(63) Continuation of application No. PCT/JP2024/017811, filed on May 14, 2024.

(30) Foreign Application Priority Data
May 23, 2023 (JP) 2023-084238

(51) Int. Cl. H01F 27/34; H01F 27/28

(52) U.S. Cl. CPC H01F 27/34; H01F 27/2804; H01F 2027/2809

(57) ABSTRACT

A coil assembly includes a plurality of coil layers stacked on one another in stacking direction. Each coil layer includes plurality of planar coils wound in planar direction perpendicular to stacking direction and electrically connected in parallel to each other between coil layers. The coil assembly includes a plurality of coil units each including at least one of planar coils disposed on a respective coil layers. The plurality of coil units are connected parallel to each other. The coil layers include first and second coil pitch layers. The first pitch coil layer has disposed thereon wound conductive wires, two adjacent ones arranged at a pitch away from each other. The second pitch coil layer has disposed wound conductive wires, two adjacent ones arranged at a pitch away from each other, first pitch being different from second pitch. The first pitch coil layer is greater than second pitch coil layer.

### CROSS REFERENCE TO RELATED DOCUMENT

The present application claims the benefit of priority of Japanese Patent Application No. 2023-84238 filed on May 23, 2023, the disclosure of which is incorporated in its entirety herein by reference.

### TECHNICAL FIELD

This disclosure generally relates to a coil assembly equipped with a plurality of planar coils.

### BACKGROUND ART

A coil assembly including a plurality of coil layers each of which a planar coil is disposed has been conventionally employed. When such a coil assembly is used in combination with a magnetic body, such as magnetic sheet, it will result in a difference in self-inductance among the planar coils due to variations in distance from each planar coil to the magnetic body. This may result in a difference in impedance among coil units each of which includes one or series-connected some of the planar coils and which are connected in parallel to each other. Such an impedance difference will cause electrical current to be concentrated in one or some of the coil units, thereby increasing power loss. In order to suppress such an impedance difference among the coil units, Japanese Patent First Publication No. 2019-186303 teaches a technique in which lengths of conductors of the planar coils on the coil layers located farther from the magnetic body are increased.

### PRIOR ART DOCUMENT

### Patent Literature

FIRST PATENT LITERATURE: Japanese Patent First Publication No. 2019-186303

### SUMMARY OF THE INVENTION

In the above-described coil assembly, mutual inductance between the coil units also affects the impedance of each of the coil units. The aforementioned technique in which the length of the conductor of each of the planar coils is adjusted as a function of the distance to the magnetic body, however, fails to take the mutual inductance between the coil units into account, which may still result in a difference in impedance among the coil units, as described above.

The above-described problem may arise not only in configurations where a magnetic body is used together with a coil assembly, but also in configurations that do not include the magnetic body. For example, the problem may occur in a coil assembly in which planar coils of respective coil layers are connected in series to form each coil unit, and a plurality of such coil units are connected in parallel. Specifically, in a coil assembly in which first to fourth coil layers are stacked in this order, a first coil unit which includes planar coils on the first coil layer and planar coils on the fourth coil layer has a greater inter-coil distance than a second coil unit which includes planar coils on the second coil layer and planar coils on the third coil layer. This causes the mutual inductance in the first coil unit to be smaller than that in the second coil unit, which may lead to the aforementioned problem. Accordingly, there is a demand for a technique capable of further suppressing current imbalance among the coil units.

According to one aspect of this disclosure, there is provided a coil assembly which comprises a plurality of coil layers which are stacked on one another in a stacking direction. Each of the coil layers includes a plurality of planar coils which are wound in a planar direction perpendicular to the stacking direction and electrically connected in parallel to each other between the coil layers. The coil assembly also includes a plurality of coil units each of which includes at least one of the planar coils disposed on a respective one of the coil layers. The plurality of coil units are connected in parallel to each other. The coil layers include a first pitch coil layer and a second coil pitch layer. The first pitch coil layer has disposed thereon wound conductive wires, two adjacent ones of which are arranged at a pitch away from each other. The second pitch coil layer has disposed thereon wound conductive wires, two adjacent ones of which are arranged at a pitch away from each other. The pitch of the first pitch coil layer is greater than the pitch of the second pitch coil layer.

According to the above-described configuration of the coil assembly, the plurality of coil layers include the first pitch coil layer and the second pitch coil layer. The pitch of the first pitch coil layer is greater than that of the second pitch coil layer, thereby eliminating a risk that a different in impedance between the coil units may occur when the magnetic member is used with the coil assembly, and the second coil layer is disposed farther away from the magnetic member than the first coil layer is, which minimizes an imbalance between electrical currents flowing through the coil units. The first pitch coil layer has disposed thereon wound conductive wires, two adjacent ones of which are arranged at a pitch away from each other. The second pitch coil layer has disposed thereon wound conductive wires, two adjacent ones of which are arranged at a pitch away from each other. The pitch of the first pitch coil layer is greater than the pitch of the second pitch coil layer. For example, when the coil assembly is designed to have a configuration where the plurality of coil layers includes a first coil layer, a second coil layer, a third coil layer, and a fourth coil layer stacked on one another in this order, the coil units include the coil unit composed of the planar coil of the first coil layer and the planar coil of the fourth coil layer, and the coil unit composed of the planar coil of the second coil layer and the planar coil of the third coil layer, and the first coil layer and the fourth coil layer are sandwiched between the second coil layer and the third coil layer, it enables a difference in mutual inductance between the coil units to be reduced, which suppresses the occurrence of a difference in impedance between the coil units.

### BRIEF DESCRIPTION OF THE DRAWINGS

The above-described object, other objects, features, or beneficial advantages in this disclosure will be apparent from the following detailed discussion with reference to the drawings.

In the drawings:

FIG. 1 is an exploded plan view illustrating a schematic configuration of a coil assembly according to one embodiment in this disclosure;

FIG. 2 is a block diagram illustrating a schematic configuration of a non-contact power transmission system (i.e., wireless power transmission system) with which a coil assembly of the first embodiment is used;

FIG. 3 is an explanatory diagram illustrating an equivalent circuit of a coil assembly of the first embodiment;

FIG. 4 is a partial cross-sectional view of a coil assembly of the first embodiment;

FIG. 5 is an explanatory diagram for describing an impedance of each coil unit in a coil assembly of the first embodiment;

FIG. 6 is a partial cross-sectional view of coil assemblies of Examples 1-1 to 1-3;

FIG. 7 is a partial cross-sectional view of a coil assembly of Comparative Example 1;

FIG. 8 is an explanatory diagram illustrating numerical analysis results of various parameters relating to impedance of coil assemblies of Examples 1-1 to 1-3 and Comparative Example 1;

FIG. 9 is a partial cross-sectional view of a coil assembly according to the second embodiment;

FIG. 10 is an explanatory diagram illustrating an equivalent circuit of a coil assembly of the second embodiment;

FIG. 11 is a partial cross-sectional view of a coil assembly according to the third embodiment;

FIG. 12 is a partial cross-sectional view of a coil assembly according to the fourth embodiment;

FIG. 13 is a partial cross-sectional view of a coil assembly according to the fifth embodiment;

FIG. 14 is a partial cross-sectional view of a coil assembly according to the sixth embodiment;

FIG. 15 is a partial cross-sectional view of a coil assembly according to the seventh embodiment;

FIG. 16 is an explanatory diagram illustrating an equivalent circuit of a coil assembly of the seventh embodiment;

FIG. 17 is a partial cross-sectional view of a coil assembly according to the eighth embodiment;

FIG. 18 is a partial cross-sectional view of a coil assembly according to the ninth embodiment;

FIG. 19 is an explanatory diagram illustrating an equivalent circuit of a coil assembly of the ninth embodiment;

FIG. 20 is a partial cross-sectional view of a coil assembly of Example 2;

FIG. 21 is a partial cross-sectional view of a coil assembly of Comparative Example 2; and

FIG. 22 is an explanatory diagram illustrating numerical analysis results of various parameters relating to impedance of coil assemblies of Example 2 and Comparative Example 2.

### MODES FOR CARRYING OUT THE INVENTION

### A. FIRST EMBODIMENT

### A1 OVERALL STRUCTURE

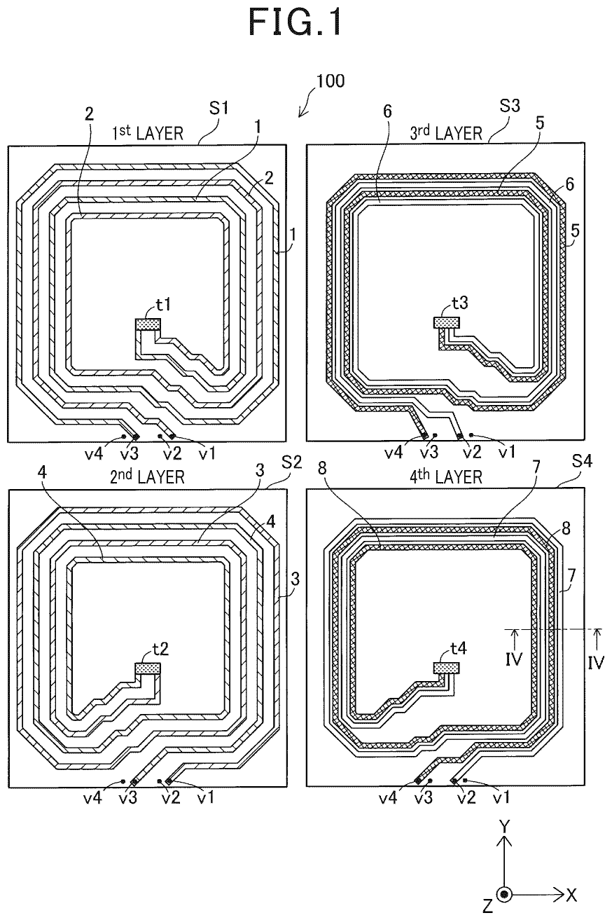

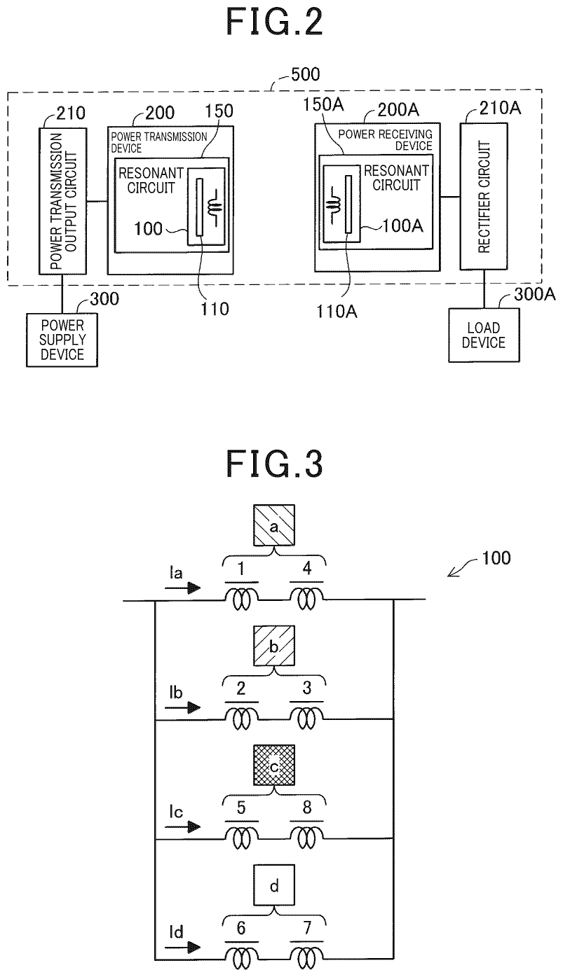

The coil assembly 100, as illustrated in FIGS. 1 and 2, includes the first coil layer S1, the second coil layer S2, the third coil layer S3, and the fourth coil layer S4. The coil assembly 100 constitutes a coil (inductor) as a whole. In this embodiment, the coil assembly 100 is used in the contactless power transfer system 500, as illustrated in FIG. 2. The configuration of the coil assembly 100 will be described later in detail. The contactless power transfer system 500 works to supply electrical power from the power transmitting device 200 in a contactless way to the power receiving device 200A and then to the load device 300A that is electrically connected to the power receiving device 200A.

The contactless power transfer system 500, as illustrated in FIG. 2, includes the resonant circuit 150 including the coil assembly 100, the power transmitting device 200 including the resonant circuit 150, the power transmission output circuit 210, the power receiver coil assembly 100A, the power receiver resonant circuit 150A including the power receiver coil assembly 100A, the power receiving device 200A including the power receiver resonant circuit 150A, and the rectifier circuit 210A.

The resonant circuit 150 includes an inductor composed of the coil assembly 100 and a capacitor (not shown) which are connected in series with each other. The power transmitting device 200 includes the resonant circuit 150, and performs contactless power supply to the power receiving device 200A using electric power supplied from the power transmission output circuit 210.

The power transmission output circuit 210 includes an inverter circuit and a filter circuit (both not shown), converts direct current power supplied from the power supply device 300 into alternating current power having a predetermined operating frequency, and removes noise components from the alternating current power before supplying it to the power transmitting device 200.

The coil assembly 100 includes the magnetic member 110. The magnetic member 110 is a thin plate-like member made of a magnetic material, and in this embodiment, it is formed of ferrite. The magnetic member 110 is, as clearly illustrated in FIG. 2, disposed in a first portion of the coil assembly 100 which is located away from a second portion of the coil assembly 100 which is located closer to, in other words, faces the power receiver coil assembly 100A. The magnetic member 110 functions to more efficiently direct a magnetic flux, linking with the coil assembly 100, toward the power receiver coil assembly 100A, thereby increasing the magnetic flux penetrating the power receiver coil assembly 100A. Details of the coil assembly 100 will be described later.

The power receiver coil assembly 100A is an inductor that constitutes a part of the resonant circuit 150A installed in the power receiving device 200A. The configuration of the power receiver coil assembly 100A is the same as that of the coil assembly 100, which will be described in detail later. Similar to the coil assembly 100, the power receiver coil assembly 100A includes the power receiver magnetic member 110A. The power receiver magnetic member 110A has a configuration similar to that of the magnetic member 110 described above. The power receiving device 200A includes the resonant circuit 150A, in which the inductor composed of the power receiver coil assembly 100A is connected in series with a capacitor (not shown). While electric power is being supplied to the power transmitting device 200, the resonant circuit 150 in the power transmitting device 200 enters a resonant state at a predetermined operating frequency, thereby generating mutual magnetic flux. The mutual magnetic flux thus generated passes through the power receiver coil assembly 100A of the power receiving device 200A, whereby an electromotive force is induced in the power receiving device 200A which carries out power transmission. The rectifier circuit 210A includes a bridge circuit (not shown) and a smoothing capacitor (not shown), and converts the alternating current power output from the power receiving device 200A into direct current power, which is supplied to the load device 300A.

The contactless power transfer system 500 having the above-described configuration may be used, for example, to supply power to a moving body, such as an electric vehicle, by disposing the power transmission output circuit 210 and the power transmitting device 200 in or on the ground, and mounting the power receiving device 200A, the rectifier circuit 210A, and the load device 300A on the moving body. In such a configuration, the load device 300A includes, for example, a battery or a motor installed in the moving body.

### A2. DETAILED STRUCTURE OF COIL ASSEMBLY 100

The coil assembly 100 demonstrated in FIG. 1 includes four coil layers S1 to S4 which are stacked on one another in the Z-axis. Specifically, the first coil layer S1, the second coil layer S2, the third coil layer S3, and the fourth coil layer S4 are sequentially laminated or stacked on one another in the +Z-direction. FIG. 1 defines mutually orthogonal X-, Y-, and Z-axes. The X-, Y-, Z-axes correspond to the X-, Y-, Z-axes shown in other drawings. A direction from the power transmitting device 200 to the power receiving device 200A, as shown in FIG. 2, corresponds to the +Z-direction. It should be noted that FIG. 1 omits the magnetic member 110 for the brevity of illustration.

Each of the coil layers S1 to S4 includes a plurality of planar coils made of conductive wires wound in the X-Y plane. In this embodiment, the conductive wires are formed of copper foil. Each of the coil layers S1 to S4 is designed to have two planar coils. Each of the coil layers S1 to S4 has a structure in which an insulating material, such as a prepreg, is interposed between coil patterns of the planar coils made of copper foil. The planar coil located on the outermost (surface side) of the coil assembly 100 may be covered with, for example, a solder resist.

The first coil layer S1 includes the first planar coil 1 and the second planar coil 2. The second coil layer S2 includes the third planar coil 3 and the fourth planar coil 4. The third coil layer S3 includes the fifth planar coil 5 and the sixth planar coil 6. The fourth coil layer S4 includes the seventh planar coil 7 and the eighth planar coil 8. The number of turns of each of the planar coils 1 to 8 is two. It should be noted that the number of turns of the planar coils 1 to 8 is not limited to two and may be any arbitrary number.

The coil assembly 100 has formed therein four through-hole vias v1, v2, v3, and v4, each penetrating the respective coil layers S1 to S4. A first end of each of the second planar coil 2 and the third planar coil 3 is connected to the through-hole via v1. A first end of each of the sixth planar coil 6 and the seventh planar coil 7 is connected to the through-hole via v2. A first end of each of the first planar coil 1 and the fourth planar coil 4 is connected to the through-hole via v3. A first end of each of the fifth planar coil 5 and the eighth planar coil 8 is connected to the through-hole via v4.

The first coil layer S1 includes the connection terminal t1 located at a central region thereof. The second coil layer S2 includes the connection terminal t2 at a central region thereof. The third coil layer S3 includes the connection terminal t3 at a central region thereof. The fourth coil layer S4 includes the connection terminal t4 at a central region thereof. The second end of the first planar coil 1 and the second end of the second planar coil 2 are connected to the connection terminal t1. The second end of the third planar coil 3 and the second end of the fourth planar coil 4 are connected to the connection terminal t2. The second end of the fifth planar coil 5 and the second end of the sixth planar coil 6 are connected to the connection terminal t3. The second end of the seventh planar coil 7 and the second end of the eighth planar coil 8 are connected to the connection terminal portion t4. The connection terminal t1 and the connection terminal t3 are electrically connected to each other via a via (not shown). The connection terminal t2 and the connection terminal t4 are electrically connected to each other via a via (not shown). The connection terminal t1 and the connection terminal t4 are exposed both to a first end face of the coil assembly 100 which faces in the −Z direction and to a second end face of the coil assembly 100 which faces in the +Z direction, respectively, and are connected to the power transmitting device 200 via a capacitor (not shown).

The first planar coil 1 and the fourth planar coil 4 are, as can be seen in FIG. 3, connected in series to form a coil unit a. Similarly, the second planar coil 2 and the third planar coil 3 are connected in series to form a coil unit b. The fifth planar coil 5 and the eighth planar coil 8 are connected in series to form a coil unit c. The sixth planar coil 6 and the seventh planar coil 7 are connected in series to form a coil unit d. These four coil units a to d are connected in parallel with one another. In the following discussion, an electrical current flowing through the coil unit a is referred to as current Ia. An electrical current flowing through the coil unit b is referred to as current Ib. An electrical current flowing through the coil unit c is referred to as current Ic. An electrical current flowing through the coil unit d is referred to as Id. The parallel connection of the four coil units a to d in the above manner results in a reduction in thickness of each conductive wire, thereby suppressing the generation of eddy currents and improving power transmission efficiency. FIG. 3 omits the magnetic member 110 for the brevity of illustration.

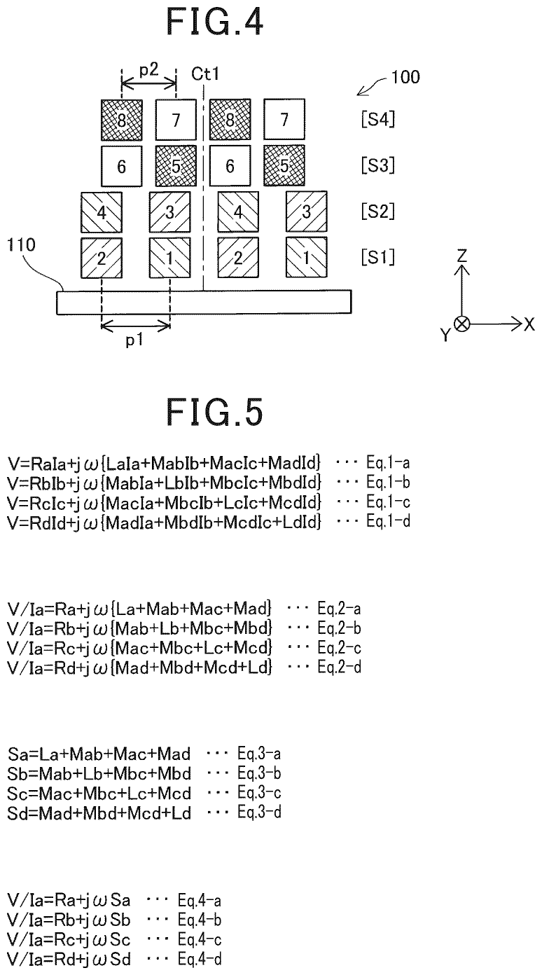

The third coil layer S3 and the fourth coil layer S4 are, as can be seen in FIG. 4, located farther from the magnetic member 110 than the first coil layer S1 and the second coil layer S2 are. A minimum interval or pitch p1 (also called a coil pitch or a winding pitch which will be referred to below as “first pitch p1”) between adjacent wound conductive wires on the first coil layer S1 in a direction (i.e., a direction along the X-Y plane; hereinafter referred to as the “in-plane direction or planar direction”), namely, between a wound conductive wire of the first planar coil 1 and a wound conductive wire of the second planar coil 2, is equal to a pitch p1 between adjacent wound conductive wires on the second coil layer S2 in the planar direction, namely, between a conductive wire of the third planar coil 3 and a conductive wire of the fourth planar coil 4. An minimum interval or pitch p2 (hereinafter referred to as “second pitch p2”) between adjacent conductive wires on the third coil layer S3 in the planar direction, namely, between a conductive wire of the fifth planar coil 5 and a conductive wire of the sixth planar coil 6, is equal to a pitch p2 between adjacent conductive wires on the fourth coil layer S4 in the planar direction, namely, between a conducive wire of the seventh planar coil 7 and a conductive wire of the eighth planar coil 8. In this embodiment, the “pitch between conductive wires” refers to a distance in the planar direction between the center in the width direction of one conductive wire and the center in the width direction of an adjacent conductive wire. The central positions Ct1 of sets of wound wire segments (i.e., parallel extending and radially adjacent segments of turns) on the coil layers S1 to S4 are aligned with each other. FIG. 4 illustrates a cross-sectional view taken along the line IV-IV in FIG. 1.

In the following discussion, each of the first coil layer S1 and the second coil layer S2 will also be referred to below as a first pitch coil layer. Each of the third coil layer S3 and the fourth coil layer S4 will also be referred to below as a second pitch coil layer.

In this embodiment, a pitch of the first pitch coil layer, that is, the first pitch p1, is greater than a pitch of the second pitch coil layer, that is, the second pitch p2. The reason for adopting such a configuration will be described below with reference to FIGS. 3 and 5.

FIG. 3 illustrates an equivalent circuit of the coil assembly 100 which is represented by Eqs. 1-a, 1-b, 1-c, and 1-d listed in an uppermost portion of FIG. 5. In each of Eqs. 1-a to 1-d, V denotes a voltage developed between terminals of each of the coil units a to d; Ra to Rd denote resistances of the respective coil units a to d; La to Ld denote self-inductances of the respective coil units a to d; and Mxy (where x and y represent a to d) denote mutual inductances between the coil unit x and the coil unit y. The symbol ω represents an angular frequency. It is to be noted that Ia to Id represent electric currents flowing through the respective coil units a to d, as described above.

When there is no imbalance in current among the four coil units a to d connected in parallel with one another, a condition Ia=Ib=Ic=Id is satisfied. Accordingly, Eqs. 1-a to 1-d may be transformed into Eqs. 2-a to 2-d shown in the second row in FIG. 5. Here, by replacing the sum of the self-inductance and mutual inductances in each of Eqs. 2-a to 2-d with a corresponding one of parameters Sa, Sb, Sc, and Sd (hereinafter referred to as “inductance parameters”), Eqs. 3-a to 3-d in the third row are obtained. Substituting Eqs. 2-a to 2-d with Eqs. 3-a to 3-d results in Eqs. 4-a to 4-d in the fourth row. In an ideal state where there is no current imbalance among the four coil units a to d, the left-hand sides of Eqs. 4-a to 4-d are all equal to “V/Ia”. A state with no current imbalance may, therefore, be achieved by meeting the resistance relation of Ra=Rb=Rc=Rd and the inductance parameter relation of Sa=Sb=Sc=Sd.

In this embodiment, with respect to the resistances Ra to Rd, conductive wires having the same thickness are employed for each of the coil units a to d. Line lengths (i.e., overall lengths) of the conductive wires of the coil units a to d are selected to be equal to each other. Specifically, as illustrated in FIG. 1, the first planar coil 1, which is wound on the radially outer side of the first coil layer S1, is connected in series with the fourth planar coil 4, which is wound on the radially inner side of the second coil layer S2, while the second planar coil 2, which is wound on the radially inner side of the first coil layer S1, is connected in series with the third planar coil 3, which is wound on the radially outer side of the second coil layer S2. This makes the overall lengths of the conductive wires of the coil units a and b equal to each other. Similarly, the fifth planar coil 5, which is wound on the radially outer side of the third coil layer S3, is connected in series with the eighth planar coil 8, which is wound on the radially inner side of the fourth coil layer S4, while the sixth planar coil 6, which is wound on the radially inner side of the third coil layer S3, is connected in series with the seventh planar coil 7, which is wound on the radially outer side of the fourth coil layer S4. This makes the overall lengths of the conductive wires of the coil units c and d equal to each other. Furthermore, the central positions of the coils a to d are made coincide at the central position Ct1, thereby enabling the overall lengths of the conductive wires of the coil units a and b and those of the coil units c and d to be substantially equal to each other.

Among the inductance parameters Sa to Sd, the self-inductances La to Ld are, in this embodiment, intended to be made uniform by using conductive wires of the same thickness and by winding the conductive wires with the same number of turns in the coil units a to d. However, the self-inductance of one of the coil units a to d which is positioned farther from the magnetic member 110 is usually smaller than that of one of the coil units a to d which is located closer to the magnetic member 110. This results in differences among the self-inductances La to Ld. To address such a drawback in this embodiment, differences are intentionally introduced in mutual inductances Mxy (x=a to d, y=a to d) by differentiating the above-described winding pitches, thereby cancelling out the above-mentioned differences in the self-inductances La to Ld. Specifically, by setting the first pitch p1 of each of the first planar coil 1 and the second planar coil 2 that are positioned closer to the magnetic member 110 to be greater than the second pitch p2 of each of the third planar coil 3 and the fourth planar coil 4 that are positioned farther from the magnetic member 110, the mutual inductance Mab is reduced, thereby canceling the relatively large self-inductance. In other words, in the coil units a and b, which have greater self-inductances La and Lb compared to the self-inductances Lc and Ld, the pitch between adjacent conductive wires is increased so as to reduce the mutual inductance Mab, thereby minimizing differences in the inductance parameters Sa to Sd. This minimizes the drawback in that the differences in impedance will occur among the coil units a to d, and reduces the increase in loss caused by current concentration into one(s) of the coil units a to d.

In the coil assembly 100 in this embodiment, by controlling the first pitch p1 and the second pitch p2 of the coil units a to d to make the inductance parameters Sa to Sd, namely, the sums of the self-inductance and the mutual inductances of the coil units a to d are equal to each other. It should be noted that the phrase “the sum of the self-inductance and the mutual inductances is equal to each other” is not limited to a case where the sums are exactly equal, but also encompasses a broader sense, including a relationship in which the difference in the inductance parameters among the coil units a to d can be reduced, as compared to a configuration in which the first pitch p1 and the second pitch p2 are equal to each other.

### A3. EXAMPLES

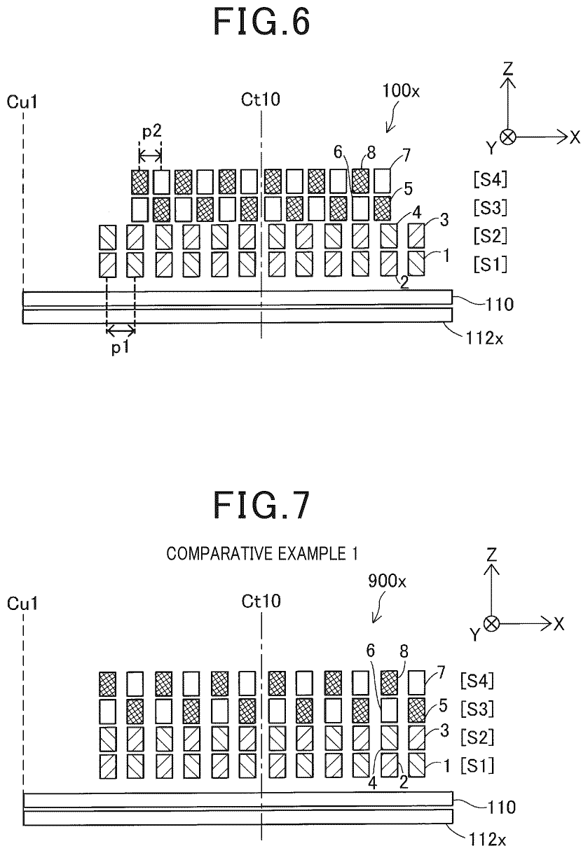

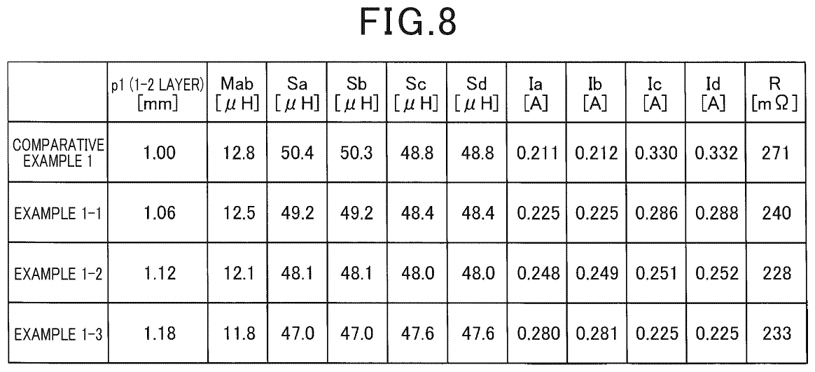

As an example of the coil assembly 100 according to the first embodiment, the coil assembly 100x shown in FIG. 6 that is an example of the coil assembly 100 in the first embodiment was subjected to numerical analysis. In addition, the coil assembly 900x shown in Fis. 7, which represents Comparative Example 1, was also subjected to numerical analysis. FIG. 8 represents results of numerical analysis of the mutual inductance Mab and the inductance parameters Sa to Sd in the coil assemblies 100x and 900x.

In the coil assembly 100x shown in FIG. 6, the number of turns of a conductive wire on each of the coil layers S1 to S4 is six. The central positions Ct10 of sets of wire segments wound on the coil layers S1 to S4 are aligned with each other. FIG. 8 is a table representing evaluated results of numerical analysis of three types of the coil assembly 100x having mutually different first pitches p1, corresponding to Examples 1-1, 1-2, and 1-3. In each of the examples 1-1 to 1-3, the distance from the central axis Cu1 of each of the coil layers S1 to S4 (i.e., an axial line extending parallel to the Z-axis from the center of each of the coil layers S1 to S4, as viewed in the Z-axis direction) to the central position Ct10 of the set of the wound wire segments on a corresponding one of the coil layers S1 to S4 is selected to be 20 mm. The thickness of each wire is set to 70 μm, and the width of each wire is set to 0.5 mm. The thickness of the magnetic member 110 is set to 1 mm, and the thickness of the aluminum shield 112x is set to 1 mm. The second pitch p2 is set to 1 mm in all examples. The first pitch p1 is set, as shown in FIG. 8, to 1.06 mm in Example 1-1, 1.12 mm in Example 1-2, and 1.18 mm in Example 1-3. On the other hand, in the coil assembly 900x of Comparative Example 1, the first pitch p1 is set to 1.00 mm, which is the same as the second pitch p2. Thus, the coil assembly 900x differs from the coil assemblies 100x of Examples 1-1 to 1-3 in terms of the first pitch p1, while the other configurations are the same. In addition, an electric current of 1 A at a frequency of 85 kHz was supplied to the coil assembly 100x. The magnetic member 110 is made of ferrite. The planar shapes of the planar coils formed on the coil layers S1 to S4, the magnetic member 110, and the aluminum shield 112x are circular when viewed in plan.

FIG. 8 shows that the reduction in mutual inductance Mab is achieved by increasing the first pitch p1. This decreases the inductance parameters Sa and Sb to eliminate the variation among the inductance parameters Sa to Sd. This results in a decrease in difference among currents Ia to Id, thereby causing the AC resistance R of the coil assembly in each of Examples 1-1 to 1-3 to be reduced as compared with that of Comparative Example 1.

The coil assembly 100 of the first embodiment is, as described above, designed to have the first pitch p1 of the first-pitch coil layers greater than the second pitch p2 of the second-pitch coil layers. The first pitch p1 is, as described above, an interval between an adjacent two of the wire segments of each of the coil units a and b in the planar direction. The second pitch p2 is an interval between an adjacent two of the wire segments of each of the coil units c and d in the planar direction. This at least partially cancels the difference in self-inductance between the coil units a and b and the coil units c and d, which arises from the difference in distance between the magnetic member 110 and the coil units a to d, thereby minimizing the difference in impedance among the coil units a to d, which suppresses current imbalance among the coil units a to d. Specifically, since the coil units a and b are located closer to the magnetic member 110 than the coil units c and d are, the self-inductance of the coil units a and b is greater than that of the coil units c and d. However, since the first pitch p1 between an adjacent two of the wire segments in the planar direction of the coil units a and b is greater than the second pitch p2 between an adjacent two of the wire segments in the planar direction of the coil units c and d, the mutual inductance in the coil units a and b is smaller than the mutual inductance in a configuration where the pitch of the coil units a and b is equal to the second pitch p2. This minimizes the variation in impedance among the coil units a to d.

Each of the coil units a to d, as described above, includes an inner planar coil(s) and an outer planar coil(s) which is located radially outside the inner planar coils(s) and electrically connected in series with the inner planar coils(s). This layout minimizes a difference in path length (i.e., an overall length) of the conductive wire among the coil units a to d, thereby suppressing a variation in impedance among the coil units a to d.

The farthest coil layer S4 located farthest from the magnetic member 110 and the coil layer S3 connected in series with the farthest coil layer S4 each have the second pitch p2 that is an interval between a radially adjacent two of the wire segments thereof and smaller than the first pitch p1 that is an interval between a radially adjacent two of the wire segments of the coil layers S1 and S2. This causes the coil units c and d which are located farther from the magnetic member 110 than the coil units a and b are and higher in self-inductance than the coil units a and b to have mutual inductances higher than those in a case where the interval between a radially adjacent two of the wire segments of each of the coil units c and d is selected to be identical with the first pitch p1. This results in a decease in variation in impedance among the coil units a to d.

The sum of the self-inductance and the mutual inductances is, as described above, set equal among the coil units a to d, thereby resulting in a decreased variation in impedance among the coil units a to d.

### B. SECOND EMBODIMENT

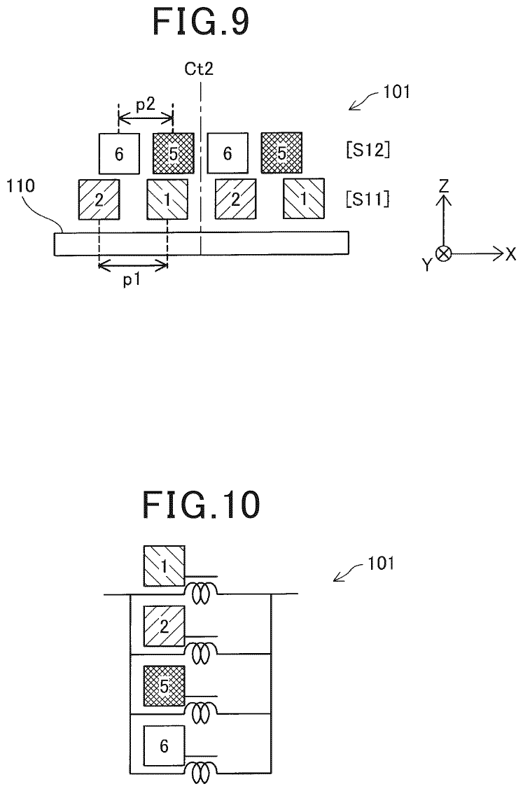

FIG. 9 illustrates the coil assembly 101 according to the second embodiment which is different from the coil assembly 100 in the first embodiment in that the coil assembly 101 includes two coil layers. Other arrangements are identical with those in the first embodiment. The same reference numbers as employed in the first embodiment will refer to the same parts, and explanation thereof in detail will be omitted here. FIG. 9 shows a cross sectional area of the coil assembly 101, as taken along the same line IV-IV as in FIG. 1. The coil assembly 101 includes the first coil layer S11 and the second coil layer S12 which are stacked on one another. The first coil layer S11 and the second coil layer S12 have substantially the same structures as those of the first coil layer S1 and the second coil layer S2 in the first embodiment.

The first coil layer S11 which is closest to the magnetic member 110, like the first coil layer S1 in the first embodiment, has the first planar coil 1 and the second planar coil 2 formed thereon. The second coil layer S22 which is farthest from the magnetic member 110, like the third coil layer S3 in the first embodiments, has the fifth planar coil 5 and the sixth planar coil 6 formed thereon. The first planar coil 1, the second planar coil 2, the fifth planar coil 5, and the sixth planar coil 6 are, as clearly illustrated in FIG. 10, connected in parallel to each other. The central positions Ctr2 of sets of wire segments of the coil layers S11 and S12 are aligned with each other.

The coil assembly 101 of the second embodiment, like the coil assembly 100 of the first embodiment, is designed to have an interval (i.e., the first pitch p1) between two wire segments arranged adjacent to each other on the first coil layer S11 in the planar direction which is greater than an interval (i.e., the second pitch p2) between two wire segments arranged adjacent to each other on the second coil layer A12 in planar direction.

The coil assembly 101 of the second embodiment described above exhibits effects similar to those of the coil assembly 100 of the first embodiment. In the second embodiment, the first coil layer S11 corresponds to the first-pitch coil layer of the present disclosure, and the second coil layer S12 corresponds to the second-pitch coil layer of the present disclosure.

### C. THIRD EMBODIMENT

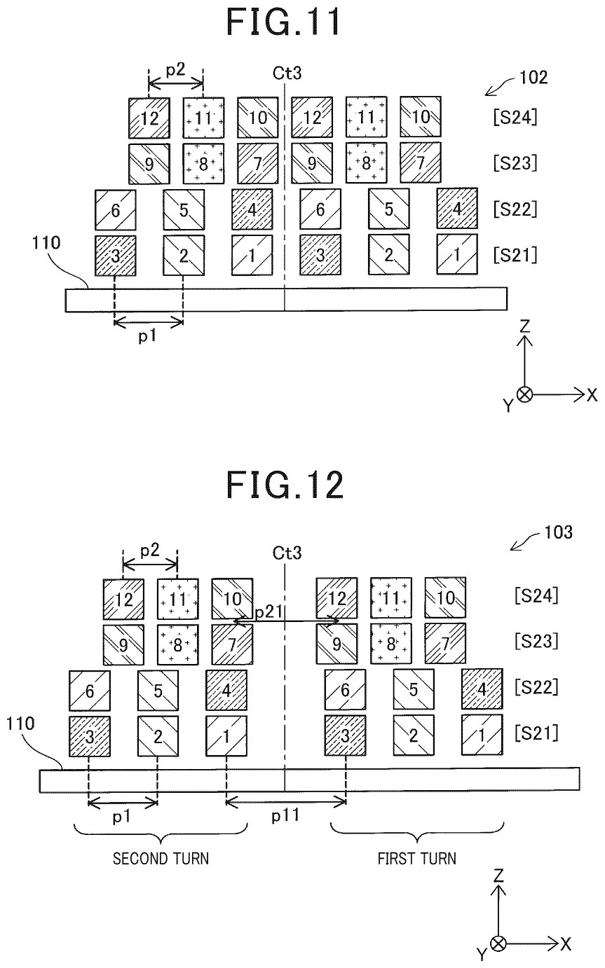

FIG. 11 illustrates the coil assembly 102 according to the third embodiment. The coil assembly 102 of the third embodiment shown in FIG. 11 includes the first coil layer S21, the second coil layer S22, the third coil layer S23, and the fourth coil layer S24, which are stacked on one another. The configuration of the first coil layer S21 to the fourth coil layer S24 is the same as that of the first coil layer S1 to the fourth coil layer S4 of the first embodiment. The coil assembly 102 differs from the coil assembly 100 of the first embodiment in that each of the coil layers S21 to S24 includes three planar coils, while the other configurations are the same. In the coil assembly 102, the same reference numerals as those of the coil assembly 100 refer to the same parts, and explanation thereof in detail will be omitted here. FIG. 11 shows a cross-sectional view taken along a position similar to the section IV-IV in FIG. 1. The central positions Ct3 of sets of wire segments of the coil layers S21 to S24 are located in coincidence with each other.

In the coil assembly 102, the first coil layer S21 includes three planar coils 1 to 3. The second coil layer S22 includes three planar coils 4 to 6. The third coil layer S23 includes three planar coils 7 to 9. The fourth coil layer S24 includes three planar coils 10 to 12. The planar coils expressed by the same type of hatching are connected in series with one another.

In the coil assembly 102 of the second embodiment, as in the coil assembly 100 of the first embodiment, the pitch (first pitch) p1 between adjacent wire segments in the planar direction on the coil layers S21 and S22 that are closer to the magnetic member 110 is greater than the pitch (second pitch) p2 between adjacent wire segments in the planar direction on the coil layers S23 and S24 that are farther from the magnetic member 110.

The coil assembly 102 of the third embodiment described above exhibits effects similar to those of the coil assembly 100 of the first embodiment. In the third embodiment, the first coil layer S21 and the second coil layer S22 correspond to the first-pitch coil layer of the present disclosure, and the third coil layer S23 and the fourth coil layer S24 correspond to the second-pitch coil layer of the present disclosure.

### D. FOURTH EMBODIMENT

The coil assembly 103 of the fourth embodiment shown in FIG. 12 differs from the coil assembly 102 of the third embodiment shown in FIG. 11 in that the pitch between radially adjacent wire segments in the planar direction is not uniform on each of the coil layers S21 to S24. In the coil assembly 103, the same reference numerals as employed for the coil assembly 102 refer to the same parts, and explanation thereof in detail will be omitted here. FIG. 12 is a cross-sectional view of the coil assembly 103 taken along the same line IV-IV in FIG. 1.

Each of the first to fourth coil layers S21 to S24, as illustrated in FIG. 12, has disposed thereon two turns: a first turn, as referred to in this embodiment, made of conductive wire extending in a first winding direction (i.e., a clockwise or a counterclockwise direction) and a second turn made of conductive wire extending in a second winding direction opposite to the first winding direction. In the structure shown in FIG. 12, the first turn is located radially outside the second turn. The pitch p11 is an interval between wire segments of the first turn and the second turn which are disposed radially adjacent to each other, in other words, close to each other in the planar direction. The first pitch p1 is, as described above, an interval between radially adjacent wire segments of each of the first turn and the second turn in the planar direction. The pitch p11 is different from the first pitch p1. Specifically, in each of the first coil layer S21 and the second coil layer S22, the pitch p11 is greater than the first pitch p1. Similarly, in each of the third coil layer S23 and the fourth col layer S24, the pitch p21 that is an interval between radially adjacent wire segments of the first turn and the second turn is greater than the second pitch p2. The pitch p11 is selected to be greater than the pitch p21. In this embodiment, the pitch p21 is also greater than the first pitch p1. However, the average value of the first pitch p1 and the pitch p11 is greater than the average value of the second pitch p2 and the pitch p21. Note that, as long as the average value of the first pitch p1 and the pitch p11 is greater than the average value of the second pitch p2 and the pitch p21, the relative relationships among the respective pitches are not limited to those described above. In the example shown in FIG. 12, the pitch between the wire segments on each of the coil layers S21 to S24 is uniform in each of the first and second turns. However, as along as the above-mentioned condition is satisfied, the pitch between an adjacent two of the wire segments on each coil layer may be different between the first and second turns. For example, on the first coil layer S21, the configuration may be such that the pitch between the first planar coil 1 and the second planar coil 2 of the first turn differs from the pitch between the first planar coil 1 and the second planar coil 2 of the second turn.

The coil assembly 103 in the above-described fourth embodiment offers substantially the same beneficial advantages as those of the coil assembly 102 in the third embodiment.

### E. FIFTH EMBODIMENT

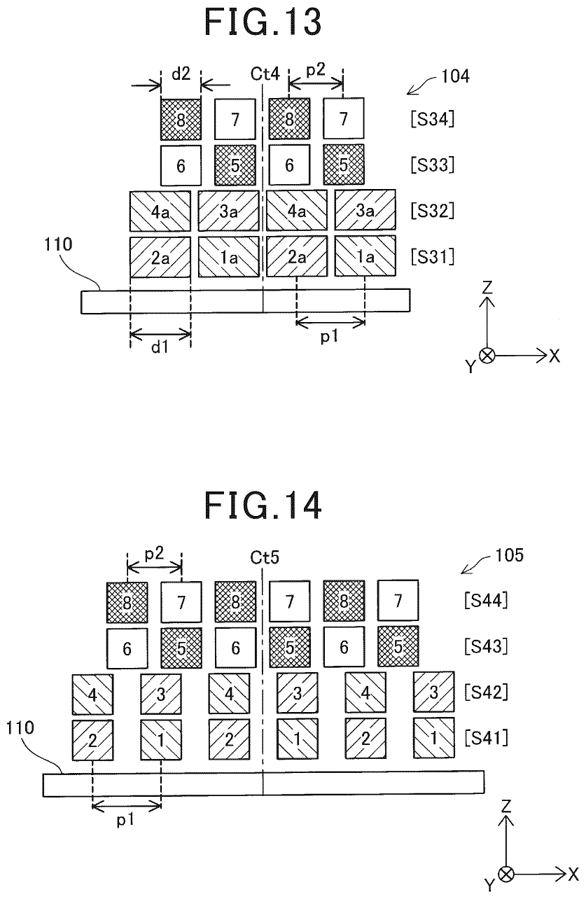

FIG. 13 illustrates the coil assembly 104 according to the fifth embodiment. The coil assembly 104 includes the first coil layer S31, the second coil layer S32, the third coil layer S33, and the fourth coil layer S34, which are stacked on one another. The configurations of the first coil layer S31 to the fourth coil layer S34 are the same as those of the first coil layer S1 to the fourth coil layer S4 in the first embodiment. The coil assembly 104 differs from the coil assembly 100 of the first embodiment in that the width of conductive wire wound on each of the first coil layer S31 and the second coil layer S32 is greater than those of the first coil layer S1 and the second coil layer S2. In the coil assembly 104, the same reference numerals as employed for the coil assembly 100 refer to the same parts, and explanation thereof in detail will be omitted here. It is to be noted that FIGS. 13 shows a cross-sectional view of the coil assembly 104 taken along the same line IV-IV as in FIG. 1.

The width d1 of the first planar coil 1a and the second planar coil 2a formed on the first coil layer S31 is equal to the width d1 of the third planar coil 3a and the fourth planar coil 4a formed on the second coil layer S32. The widths d1 are greater than the width d2 of the planar coils 5 to 8 formed on the third coil layer S33 and the fourth coil layer S34. With such a configuration, a distance or interval between two of wire segments arranged adjacent to each other in the planar direction on each of the first coil layer S31 and the second coil layer S32 (i.e., the size of a clearance between the conductive wires) is smaller than that on the third coil layer S33 and the fourth coil layer S34. However, also in the fifth embodiment, the pitch p1 between adjacent wire segments in the planar direction (i.e., the first pitch) on the first coil layer S31 and the second coil layer S32 is greater than the pitch p2 between adjacent wire segments in the planar direction (second pitch) on the third coil layer S33 and the fourth coil layer S34. The distance between the adjacent wire segments in the planar direction (i.e., the size of the clearance between the conductive wires) on the first coil layer S31 and the second coil layer S32 may alternatively be selected to be equal to that on the third coil layer S33 and the fourth coil layer S34.

The coil assembly 104 of the fifth embodiment described above exhibits effects similar to those of the coil assembly 100 of the first embodiment. In the fifth embodiment, the first coil layer S31 and the second coil layer S32 correspond to the first-pitch coil layer referred to in this disclosure. Similarly, the third coil layer S33 and the fourth coil layer S34 correspond to the second-pitch coil layer referred to in this disclosure.

### F. SIXTH EMBODIMENT

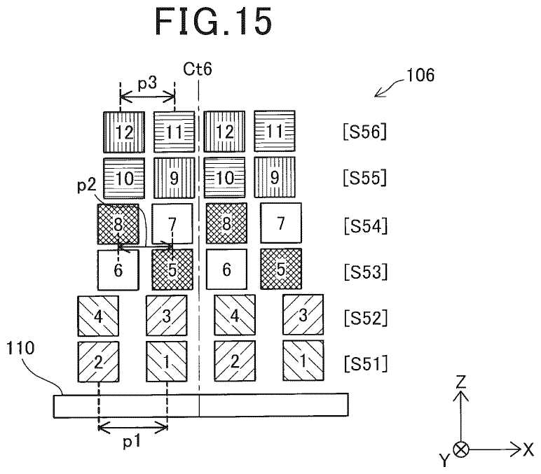

The coil assembly 105 according to the sixth embodiment, as illustrated in FIG. 14, includes the first coil layer S41, the second coil layer S42, the third coil layer S43, and the fourth coil layer S44, which are stacked on one another. The configurations of the first coil layer S41 to the fourth coil layer S44 are the same as those of the first coil layer S1 to the fourth coil layer S4 in the first embodiment. However, the coil assembly 105 differs from the coil assembly 100 of the first embodiment in that the number of turns of each planar coil is three. In the coil assembly 105, the same reference numerals are assigned to components having the same configurations as those of the coil assembly 100, and redundant descriptions thereof are omitted. FIG. 14 is a cross-sectional view taken along the same line IV-IV as in FIG. 1. The central positions Ct5 of the sets (i.e., a bundle) of the wire segments on the coil layers S41 to S44 are aligned with one another.

The coil assembly 105 of the sixth embodiment described above exhibits effects similar to those of the coil assembly 100 of the first embodiment. In the sixth embodiment, the first coil layer S41 and the second coil layer S42 correspond to the first-pitch coil layer referred to in this disclosure. Similarly, the third coil layer S43 and the fourth coil layer S44 correspond to the second-pitch coil layer referred to in this disclosure.

### G. SEVENTH EMBODIMENT

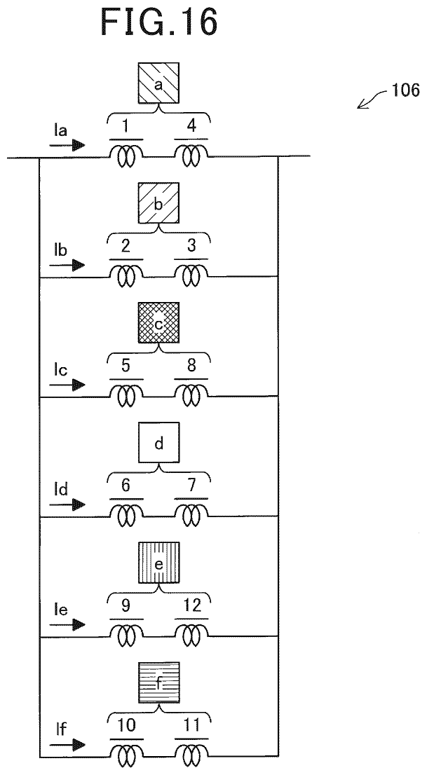

The coil assembly 106 according to the seventh embodiment, as illustrated in FIGS. 15 and 16, includes the first coil layer S51, the second coil layer S52, the third coil layer S53, the fourth coil layer S54, the fifth coil layer S55, and the sixth coil layer S56, which are stacked on one another. The coil assembly 106 differs from the coil assembly 100 of the first embodiment in that it includes six coil layers. In the coil assembly 106, the same reference numerals are assigned to components having the same configurations as those of the coil assembly 100, and redundant descriptions thereof are omitted. FIG. 15 is a cross-sectional view taken along the same line IV-IV as in FIG. 1. The central positions Ct6 of the sets of wire segments on the first to sixth coil layers S51 to S56 are aligned with one another.

The configurations of the first coil layer S51 to the fourth coil layer S54 are the same as those of the first coil layer S1 to the fourth coil layer S4 in the first embodiment. The fifth coil layer S55 includes the ninth planar coil 9 and the tenth planar coil 10. The sixth coil layer S56 includes the eleventh planar coil 11 and the twelfth planar coil 12. The ninth planar coil 9 and the twelfth planar coil 12 are, as illustrated in FIG. 16, connected in series to form the coil unit e. Similarly, the tenth planar coil 10 and the eleventh planar coil 11 are connected in series to form the coil unit f. The coil units e and f are connected in parallel with the other coil units a to d.

The pitches p3 (each of which will also be referred to below as a third pitch p3) which are intervals each between two wire segments arranged adjacent to each other on the fifth coil layer S55 and the sixth coil layer S56 in the planar direction are, as illustrated in FIG. 15, identical with each other and smaller than the second pitch p2.

The coil assembly 106 of the seventh embodiment described above exhibits effects similar to those of the coil assembly 100 of the first embodiment. In the seventh embodiment, the first coil layer S51 and the second coil layer S52 correspond to the first-pitch coil layer referred to in this disclosure. Similarly, the third coil layer S53 and the fourth coil layer S54 correspond to the second-pitch coil layer referred to in this disclosure. The third coil layer S53 and the fourth coil layer S54 correspond to the first-pitch coil layer referred to in this disclosure. Similarly, the fifth coil layer S55 and the sixth coil layer S56 correspond to the second-pitch coil layer referred to in this disclosure. The first coil layer S51 and the second coil layer S52 correspond to the first-pitch coil layer referred to in this disclosure. Similarly, the fifth coil layer S55 and the sixth coil layer S56 correspond to the second-pitch coil layer referred to in this disclosure.

### EIGHTH EMBODIMENT

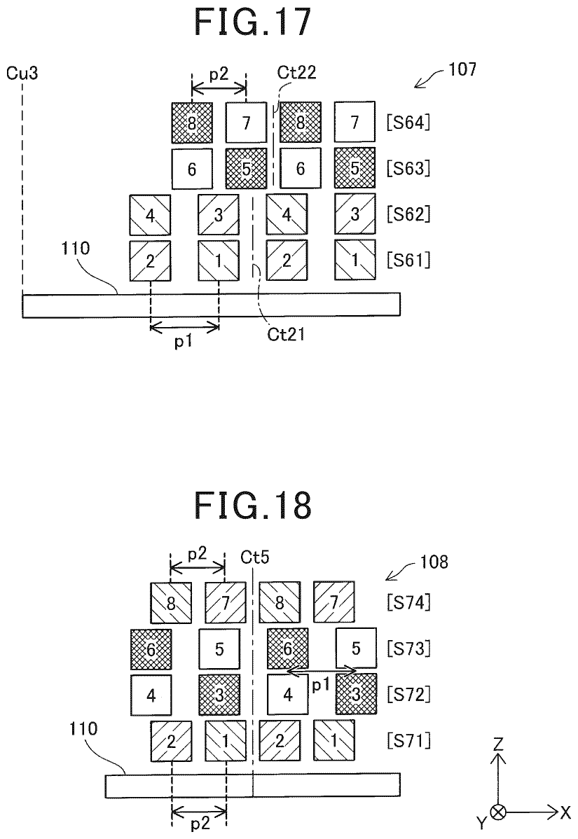

The coil assembly 107 according to the eighth embodiment, as illustrated in FIG. 17, includes the first coil layer S61, the second coil layer S62, the third coil layer S63, and the fourth coil layer S64, which are stacked on one another. The configurations of the first coil layer S61 to the fourth coil layer S64 are the same as those of the first coil layer S1 to the fourth coil layer S4 in the first embodiment. However, the coil assembly 107 differs from the coil assembly 100 of the first embodiment in that the central positions of the sets of wire segments on the coil layers S61 and S62 are different from those on the coil layers S63 and S64, while the other configurations are the same. In the coil assembly 107, the same reference numerals are assigned to components having the same configurations as those of the coil assembly 100, and redundant descriptions thereof are omitted. It is to be noted that FIG. 17 is a cross-sectional view taken along the same line IV-IV as in FIG. 1.

Compared to the central positions Ct21 of the sets of wire segments on the coil layers S61 and S62, the central positions Ct22 of the sets of wire segments on the coil layers S63 and S64 are located farther from the central axes Cu3 of the coil layers S63 and S64.

The coil assembly 107 of the eighth embodiment described above exhibits effects similar to those of the coil assembly 100 of the first embodiment. In the eighth embodiment, the first coil layer S61 and the second coil layer S62 correspond to the first-pitch coil layer referred to in this disclosure. Similarly, the third coil layer S63 and the fourth coil layer S64 correspond to the second-pitch coil layer referred to in this disclosure.

### I. NINTH EMBODIMENT

### I1. DEVICE STRUCTURE

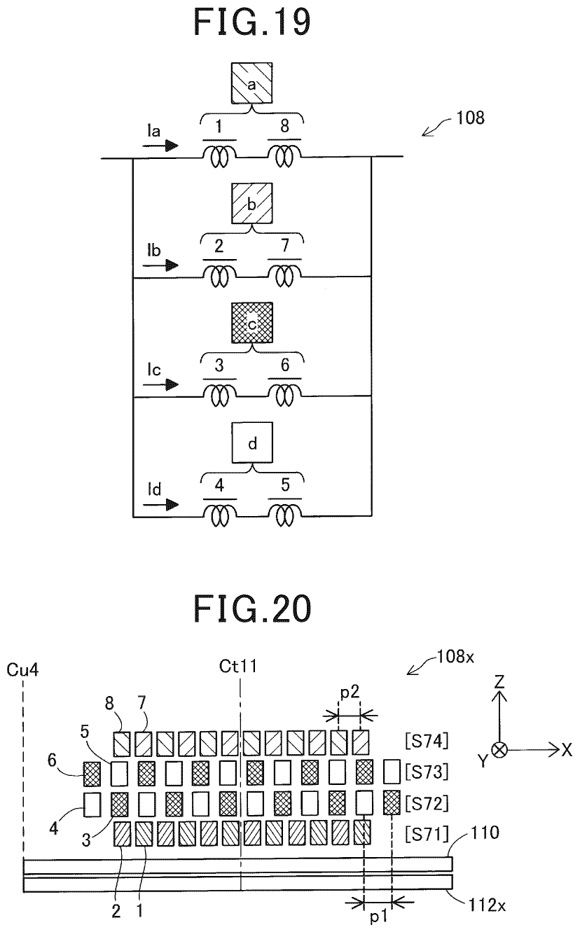

FIGS. 18 and 19 illustrate the coil assembly 108 which includes the first coil layer S71, the second coil layer S72, the third coil layer S73, and the fourth coil layer S74, which are stacked on one another. Configurations of the first coil layer S71 to the fourth coil layer S74 are the same as those of the first coil layer S1 to the fourth coil layer S4 in the first embodiment. The coil assembly 108 differs from the coil assembly 100 of the first embodiment in layout of electrical connections the coil units 1 to 8, and other configurations are the same. In the coil assembly 108, the same reference numerals are used for components having the same configuration as the coil assembly 100, and detailed description thereof will be omitted. FIG. 18 is a cross sectional view taken along the same line IV-IV as that in FIG. 1.

The coil assembly 108 in the ninth embodiment is, as can be seen in FIG. 19, designed to have the first planar coil 1 and the eighth planar coil 8 which are electrically connected in series with each other to make the coil unit a. The coil assembly 108 also has the second planar coil 2 and the seventh planar coil 7 which are electrically connected in series with each other to make the coil unit b. Similarly, the third planar coil 3 and the sixth planar coil 6 are connected in series with each other to form the coil unit c. The fourth planar coil 4 and the fifth planar coil 5 are connected in series with each other to form the coil unit d.

In the ninth embodiment, a pitch, i.e., an interval between wire segments arranged adjacent to each other in the planar direction on each of the first coil layer S71 and the fourth coil layer S74 is, as illustrated in FIG. 18, selected to be identical with the second pitch p2. A pitch between wire segments arranged adjacent to each other in the planar direction on the second coil layer S72 and the third coil layer S73 is selected to be identical with the first pitch p1.

In the coil assembly 108 of the ninth embodiment, the coil unit a and the coil unit b are arranged with the coil unit c and the coil unit d interposed therebetween, so that a distance between planar coils of the coil unit c and the coil unit d is smaller than that between planar coils of the coil unit a and the coil unit b. Accordingly, the mutual inductance Mcd is enabled to be greater than the mutual inductance Mab. However, as described above, since the second pitch p2 between wire segments arranged adjacent to each other in the planar direction on the first coil layer S71 and the fourth coil layer S74 (i.e., an interval between adjacent wire segments of the coil unit a and the coil unit b) is smaller than the first pitch p1 between wire segments in the planar direction on the second coil layer S72 and the third coil layer S73 (i.e., an interval between adjacent wire segments of the coil unit c and the coil unit d), the mutual inductance Mab can be made greater than a mutual inductance in a configuration in which the pitch between the wire segments on the first coil layer S71 and the fourth coil layer S74 is equal to the first pitch p1. Therefore, overall, differences between the respective mutual inductances Mab and Mcd may be suppressed, and differences between inductance parameters Sa to Sd may also be suppressed.

### I2. EXAMPLES

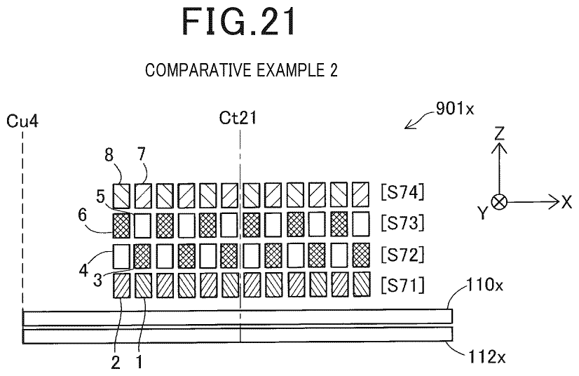

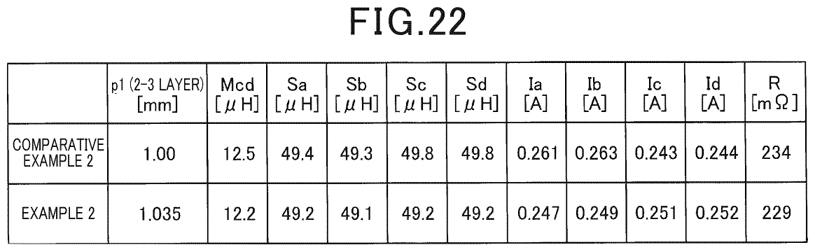

As an example of the coil assembly 108 of the ninth embodiment, the coil assembly 108x shown in FIG. 20 was subjected to numerical analysis, and the coil assembly 901x of Comparative Example 2 shown in FIG. 21 was also subjected to numerical analysis. Then, as shown in FIG. 22, mutual inductance, inductance parameters, and the like of the coil assemblies 108x and 901x were numerically analyzed to confirm their effects.

In the coil assembly 108x of Example 2 shown in FIG. 20, the number of turns of conductive wires on each of the coil layers S71 to S74 was set to six. In each of the coil layers S71 to S74, the central positions Ct11 of sets of wire segments wound thereon were aligned with one another. As shown in FIG. 22, in the coil assembly 108x, the first pitch p1 was set to 1.035 mm. The second pitch p2 was set to 1.000 mm. In Example 2, except for a distance from the central axis Cu4 of each of the coil layers S71 to S74 (i.e., a line extending in parallel with the Z-axis from the center of each of the coil layers S71 to S74 when viewed in the Z-axis direction) to the central position Ct11, the thickness and the width of the conductive wires were the same as those in Examples 1-1 to 1-3 described above, and therefore, description thereof will be omitted. On the other hand, in the coil assembly 901x of Comparative Example 2, a size of the first pitch p1 was set to 1.000 mm so as to be the same as the second pitch p2, which is different from the coil assembly 108x of Example 2, and the other configurations were the same. In addition, an electrical current of 1 A was supplied to the coil assembly 108x at a frequency of 85 kHz. The magnetic member 110 was made of ferrite. Furthermore, planar coils constituting each of the coil layers S71 to S74, the magnetic member 110, and a planar shape of the aluminum shield 112x in a plan view were circular.

FIG. 22 shows that the mutual inductance Mcd in Example 2 is reduced by increasing the first pitch p1 on the second coil layer S72 and the third coil layer S73 as compared with Comparative Example 2. This enables the inductance parameters Sc and Sd to be reduced in Example 2, thereby minimizing differences among the inductance parameters Sa to Sd. In Example 2, differences among the currents Ia to Id are, therefore, decreased as compared with Comparative Example 2, and an AC resistance R of the coil assembly is kept lower than that of Comparative Example 2.

The coil assembly 108 of the ninth embodiment described above exhibits effects similar to those of the coil assembly 100 of the first embodiment. In the ninth embodiment, the first coil layer S71 and the fourth coil layer S74 correspond to the second pitch coil layers referred to in this disclosure. Similarly, the second coil layer S72 and the third coil layer S73 correspond to the first pitch coil layers referred to in this disclosure.

### J. OTHER EMBODIMENTS

J1 The coil assembly 108 of the ninth embodiment may be designed not to have the magnetic member 110. Even in such a configuration, a difference in mutual inductance caused by a difference between a distance between the first coil layer S71 and the fourth coil layer S74 and a distance between the second coil layer S72 and the third coil layer S73 can be at least partially canceled by a difference in mutual inductance resulting from the second pitch p2 on the first coil layer S71 and the fourth coil layer S74 being smaller than the first pitch p1 on the second coil layer S72 and the third coil layer S73. Therefore, such a configuration also offers substantially the same beneficial advantages as those provided by the coil assembly 108 of the ninth embodiment.
J2. In the eighth embodiment, the central positions Ct21 of the sets of wire segments on the first coil layer S61 and the second coil layer S62 are, as described above, aligned with each other. Similarly, the central positions Ct22 of the sets of wire segments on the third coil layer S63 and the fourth coil layer S64 are aligned with each other. This disclosure, however, is not limited thereto. At least a part of the coil layers S61 to S64 may have a configuration in which the central position of the sets of wire segments differs from that of another coil layer. Such a configuration offers substantially the same beneficial advantages as those provided by the coil assembly 107 of the eighth embodiment.
J3. The coil assemblies 100 to 108 of the respective embodiments are merely examples, and various modifications may be made. For example, in each of the coil layers S1 to S4, S11 to S12, S21 to S24, S31 to S34, S41 to S44, S51 to S56, S61 to S64, and S71 to S74, a planar shape (i.e., a shape when viewed in the Z-axis direction) is not necessarily rectangular as in the respective embodiments, and may be, for example, circular, elliptical, or an R-rectangular shape having rounded corners. The number of coil layers is not limited to two, four, or six, and may be any plural number. Further, for example, in the first embodiment, the pitch between a respective two of the wire segments arranged adjacent to each other on the first coil layer S1 may not be equal to that on the second coil layer S2. Similarly, the pitch between a respective two of the wire segments arranged adjacent to each other on the third coil layer S3 may not be equal to that on the fourth coil layer S4. In addition, in the respective embodiments, the coil layer farthest from the magnetic member 110 is designed as the second pitch coil layer, but the coil layer farthest from the magnetic member 110 may alternatively be selected as the first pitch coil layer. Even in such a configuration, by configuring at least one of the second pitch coil layers to be farther from the magnetic member 110 than at least one of the first pitch coil layers is, differences in impedance between the coil units can be minimized as compared with a configuration in which all of the second pitch coil layers are closer to the magnetic member 110 than all of the first pitch coil layers are.

The present disclosure is not limited to the respective embodiments described above, and may be implemented in various configurations without departing from the spirit thereof. For example, a technical feature of an embodiment corresponding to a technical feature of a mode described in the section of Summary of the Invention may be appropriately replaced with or combined with another technical feature of the embodiment, in order to solve at least part of the above-described problems or to achieve at least part of the above-described effects. In addition, unless the technical feature is described in this specification as being essential, the technical feature can be deleted as appropriate.

The following discussion will refer to the features offered in this disclosure.

### First Aspect

A coil assembly (100 to 108) which comprises: (a) a plurality of coil layers (S1 to S4, S11 to S12, S21 to S24, S31 to S34, S41 to S44, S51 to S56, S61 to S64, S71 to S74) which are stacked on one another in a stacking direction (Z), each of the coil layers including a plurality of planar coils (1 to 8, 1, 2, 5, 6, 1 to 12, 1a to 4a, 5 to 8) which are wound in a planar direction (X-Y) perpendicular to the stacking direction and electrically connected in parallel to each other between the coil layers; and (b) a plurality of coil units (a to d, a to f) each of which includes at least one of the planar coils disposed on a respective one of the coil layers, the plurality of coil units being connected in parallel to each other. The coil layers include a first pitch coil layer (S1, S2, S11, S21, S22, S31, S32, S41, S2, S51, S52, S53, S54, S61, S62, S72, S73) and a second coil pitch layer (S3, S4, S12, S23, S24, S33, S34, S43, S44, s53, S54, S55, S56, S63, S64, S71, S74). The first pitch coil layer has disposed thereon wound conductive wires, two adjacent ones of which are arranged at a pitch (p1) away from each other. The second pitch coil layer has disposed thereon wound conductive wires, two adjacent ones of which are arranged at a pitch (p2, p3) away from each other. The pitch of the first pitch coil layer is different from that of the second pitch coil layer. The pitch of the first pitch coil layer is greater than the pitch of the second pitch coil layer.

### Second Aspect

The coil assembly as set forth in the above-described first aspect, wherein each of the coil units includes the planar coils which are disposed on two or more of the coil layers and connected in series with each other. The coil layers include a first coil layer and a second coil layer each of which has disposed thereon the planar coils including a radially inner planar coil and a radially outer planar coil. Each of the coil units includes the radially inner planar coil disposed on the first coil layer and the radially outer planar coil disposed on the second coil layer.

### Third Aspect

The coil assembly as set forth in the above-described first aspect, further comprising a magnetic member (110). The coil layers include first pitch coil layers and second pitch coil layers. Each of the first pitch coil layers has disposed thereon wound conductive wires, two adjacent ones of which are arranged at a pitch (p1) away from each other. Each of the second pitch coil layers has disposed thereon wound conductive wires, two adjacent ones of which are arranged at a pitch (p2, p3) away from each other. The coil layers are stacked on one another on the magnetic member. The planar coils of at least one of the second coil layers are located farther away from the magnetic member than the planar coils of at least one of the first coil layers are.

### Fourth Aspect

The coil assembly as set forth in the above-described third aspect, wherein the second pitch coil layers include a farthest coil layer that is one of the coil layers which is located farthest at least from the magnetic member. At least one of the coil layers other than the farthest coil layer is included in the first pitch coil layers.

### Fifth Aspect

The coil assembly as set forth in the above-described fourth aspect, wherein the second pitch coil layers include the farthest coil layer and one of the coil layers which is connected in series with the farthest coil layer. All the coil layers other than the farthest coil layer and the one of the coil layers connected in series with the farthest coil layer are included in the first pitch coil layers.

### Sixth Aspect

The coil assembly as set forth in any one of the above-described first to fifth aspect, wherein sums of self-inductances and mutual inductances of the coil units are equal to each other.

1. A coil assembly comprising:
a plurality of coil layers which are stacked on one another in a stacking direction, each of the coil layers including a plurality of planar coils which are wound in a planar direction perpendicular to the stacking direction and electrically connected in parallel to each other between the coil layers; and
a plurality of coil units each of which includes at least one of the planar coils disposed on a respective one of the coil layers, the plurality of coil units being connected in parallel to each other, wherein
the coil layers include a first pitch coil layer and a second coil pitch layer, the first pitch coil layer having disposed thereon wound conductive wires, two adjacent ones of which are arranged at a pitch away from each other, the second pitch coil layer having disposed thereon wound conductive wires, two adjacent ones of which are arranged at a pitch away from each other, the pitch of the first pitch coil layer being different from that of the second pitch coil layer, and
the pitch of the first pitch coil layer is greater than the pitch of the second pitch coil layer.

2. The coil assembly as set forth in claim 1, wherein each of the coil units includes the planar coils which are disposed on two or more of the coil layers and connected in series with each other, and
the coil layers include a first coil layer and a second coil layer each of which has disposed thereon the planar coils including a radially inner planar coil and a radially outer planar coil, each of the coil units includes the radially inner planar coil disposed on the first coil layer and the radially outer planar coil disposed on the second coil layer.

3. The coil assembly as set forth in claim 1 further comprising a magnetic member, and wherein the coil layers include first pitch coil layers and second pitch coil layers,
the coil layers are stacked on one another on the magnetic member, and
the planar coils of at least one of the second coil layers are located farther away from the magnetic member than the planar coils of at least one of the first coil layers are.

4. The coil assembly as set forth in claim 3, wherein the second pitch coil layers include a farthest coil layer that is one of the coil layers which is located farthest at least from the magnetic member, and
at least one of the coil layers other than the farthest coil layer is included in the first pitch coil layers.

5. The coil assembly as set forth in claim 4, wherein the second pitch coil layers include the farthest coil layer and one of the coil layers which is connected in series with the farthest coil layer, and all the coil layers other than the farthest coil layer and the one of the coil layers connected in series with the farthest coil layer are included in the first pitch coil layers.

6. The coil assembly as set forth in claim 1, wherein sums of self-inductances and mutual inductances of the coil units are substantially equal to each other.

7. The coil assembly as set forth in claim 2, wherein sums of self-inductances and mutual inductances of the coil units are substantially equal to each other.

8. The coil assembly as set forth in claim 3, wherein sums of self-inductances and mutual inductances of the coil units are substantially equal to each other.

9. The coil assembly as set forth in claim 4, wherein sums of self-inductances and mutual inductances of the coil units are substantially equal to each other.

10. The coil assembly as set forth in claim 5, wherein sums of self-inductances and mutual inductances of the coil units are substantially equal to each other.
